(19) United States
(12) Patent Application Publication
(10) Pub. No.: US 2023/0088729 A1
(43) Pub. Date: Mar. 23, 2023

(54) USER-LEVEL REWARD OFFER INTERFACE AND MANAGEMENT

(71) Applicant: VIASAT, INC., Carlsbad, CA (US)

(72) Inventors: Fergal Murray, Tomhaggard (IE); Micheal Gregory Solomon, Ballyleague (IE)

(73) Assignee: VIASAT, INC., Carlsbad, CA (US)

(21) Appl. No.: 17/947,015

(22) Filed: Sep. 16, 2022

Related U.S. Application Data
(60) Provisional application No. 63/245,479, filed on Sep. 17, 2021.

(51) Int. Cl. G06Q 30/02

(52) U.S. Cl. CPC G06Q 30/0208; G06Q 30/0239; G06Q 30/0265

(57) ABSTRACT

Methods, systems, and devices for providing in-flight communication sessions. In some examples, a communication session delivery system may provide network access service once a passenger has completed a brand interaction. The brand interaction may be required in exchange for access to content. An example method may include identifying reward offers comprising respective brand interactions with brand partners and rewards related to the communication sessions. Some of the reward offers may be associated with different reward offer types, which may be associated with levels of engagement with brand partner services by passengers. A first group of reward offers having first respective proportions of the reward offer types may be presented to a passenger. An indication of completion of a brand interaction associated with a selected reward offer may be received. A second group of reward offers having second respective proportions of the reward offer types may be presented.

### CROSS-REFERENCE TO RELATED APPLICATIONS

The present application for patent claims the benefit of U.S. Provisional Patent Application No. 63/245,479 by MURRAY et al., entitled “USER-LEVEL REWARD OFFER INTERFACE AND MANAGEMENT,” filed Sep. 17, 2021, which is assigned to the assignee hereof and which is expressly incorporated by reference in its entirety herein.

### BACKGROUND

The following relates generally to communication session delivery systems, and more specifically to techniques for a user-level reward offer interface and management.

Increasingly, passengers on commercial aircraft or other transit vehicles such as buses, trains, boats, and the like, desire broadband network access while in transit. Additionally, passenger vehicles often include vehicle information systems to satisfy the desire of the passenger to access viewing content, such as entertainment, information content or other viewing content, while on the move. Passenger aircraft may receive network access service via a shared communication link such as a satellite communication link. The aircraft may have an on-board multi-user access terminal that communicates with ground stations (e.g., via a satellite of a satellite communication system) and provides network access connectivity for the passengers. For example, users may connect their communication devices (e.g., smartphones, laptops, tablets, etc.) to a wireless local area network (WLAN) served by the multi-user access terminal, which routes data communications to other networks (e.g., the Internet) via the shared communication link.

As passenger demand for broadband access and viewing content continues to evolve, operators of communication session delivery systems have devised various techniques to monetize the services in order to provide passengers reliable and pleasing experiences. However, different monetization techniques may lead to varying levels of satisfaction for the passenger. For example, separately charging passengers for access to communication sessions may lead to passenger frustration because they may feel as though the operator of the passenger vehicle is charging them for every additional service option during a trip. In view of the above, there is a need for improved communication session delivery systems associated with passenger vehicles to overcome the shortcomings of conventional communication session delivery systems.

### SUMMARY

The described techniques relate to improved methods, systems, devices, and apparatuses that support techniques for a user-level reward offer interface and management. In some examples, a communication session delivery system may provide network access service or other types of content once a passenger has completed a brand interaction. The brand interaction may be any number of options that a brand partner may require in exchange for access to content. The communication session delivery system may choose from a plurality of reward offers of a plurality of reward offer types and then display the chosen offers to a passenger. The chosen offers may be selected based on profile information of a passenger and characteristics targeted by a brand partner. The passenger may then choose a reward offer and perform the required brand interaction. Once the brand interaction has been verified, the passenger may receive the reward associated with the offer. The passenger may complete the reward, such as network access for a determined time period. The communication session delivery system may choose a second group of reward offers from the plurality of reward offers of the plurality of reward offer types and then display the second group of chosen offers to the passenger.

### BRIEF DESCRIPTION OF THE DRAWINGS

FIG. 1 illustrates an example of a system for wireless communications that supports techniques for user-level reward offer interface and management in accordance with aspects of the present disclosure.

FIG. 2 illustrates an example of a system for wireless communications that supports techniques for user-level reward offer interface and management in accordance with aspects of the present disclosure.

FIG. 3 illustrates an example of a process flow that supports techniques for user-level reward offer interface and management in accordance with aspects of the present disclosure.

FIGS. 4 through 7 illustrate example graphical representation of a session interaction interfaces that support techniques for user-level reward offer interface and management in accordance with aspects of the present disclosure.

FIGS. 8 and 9 show block diagrams of devices that support techniques for offers for user-level reward offer interface and management in accordance with aspects of the present disclosure.

FIG. 10 shows a flowchart illustrating a method that supports techniques for offers for user-level reward offer interface and management in accordance with aspects of the present disclosure.

### DETAILED DESCRIPTION

A commercial passenger vehicle may support a shared communication link for network access service for passengers. For example, users may connect their communication devices to a wireless local area network (WLAN), which routes data communications to other networks (e.g., the Internet) via the shared communication link. The shared communication link may be a wireless link (e.g., cellular link, satellite communication link, etc.), and may be able to support wider bandwidth applications such as web browsing, multimedia streaming, or video communications.

Providing such network access and content services provides entertainment and comfort for a passenger during a travel segment, however, providing such services incurs costs to the travel provider. The travel provider may choose from a variety of monetization techniques in order to provide reliable and satisfactory communication session services to its passengers, including charging separate fees for chosen services, inserting ads, and the like. However, charging separate fees may lead to passenger discontentment, while inserted ads have varying levels of efficacy in user engagement.

The described features relate to a communication session delivery system which delivers communication sessions to a passenger based on completed brand interactions chosen by the passenger. Completing brand interactions chosen by the passenger may improve the experience for both the passenger and a brand partner because the passenger may engage with an interaction that he or she is most interested in, and in turn, the brand partner will have a higher value interaction with the passenger than other methods, such as untargeted ads.

Prior to or during a travel segment, brand partners or another entity may identify a number of reward offers to present to the passengers of a travel segment, where the reward offers may consist of a communication session in exchange for a passenger completing a brand interaction. A communication session delivery system may present a variety of selected reward offers of a plurality of reward offer types to a passenger through a user interface such as a portal, application, and the like. The passenger may access the user interface before and/or during the travel segment and may choose an offer.

An offer may be associated with one or more characteristics of a communication session that can be provided to the passenger for using the shared communication link upon completing interaction with the offer. The characteristic(s) of the communication session can vary from offer to offer and can be different in different examples. The characteristic(s) of the communication session may, for example, be one or more of a total amount of time allotted to the communication session, a data rate of the communication session, a total amount of data communicated during the communication session, access to one or more service types (e.g., text, email, streaming, etc.), access to one or more network destinations (e.g., a streaming video service provider, etc.), and combinations thereof.

The type of interaction to be completed by the passenger can vary from offer to offer and can be different in different examples. For example, the interaction may be completing viewing of a video associated with the offer. As another example, the example may be creating a social media post about a particular brand associated with the offer. Other example reward offer types may include buying a product or service, signing up for a service, newsletter, or the like, providing an email address, interacting with a brand's website, or trying a product, service, or other offering.

Once the brand interaction has been verified, the communication session delivery system may provide the offered network access time to the passenger for use during the travel segment. The manner in which the communication session is provided to the passenger can vary between examples. In some examples, the communication session may be attributed to a user account of the passenger managed by the communication session delivery system. In such a case, the passenger may choose when to use the communication session, such as on the current travel segment and/or on different travel segments (e.g., on the same or different airlines or other transportation providers). In other examples, the communication session may be attributed to the communication device used by the passenger without requiring the passenger create a user account.

Once a brand interaction has been verified for the selected reward offer of the first group of reward offers, the communication session delivery system may record the successful interaction. The communication session delivery system may log multiple successful interactions to determine which interactions and offers users prefer. This information may be provided to brand partners in order to inform their reward offers, and travel providers may use the information to inform which reward offers they may present to passengers. Thus, the experience for both passengers and brand partners may be continually improved upon.

Once the passenger has completed the first brand interaction, the communication session delivery system may provide a second group of reward offers of the plurality of reward offers. The second group of reward offers may be different from the first group of reward offers and may have different proportions of the reward offer types. For example, the first group of reward offers may be associated with rewards of a first level (e.g., 5 minutes of network access, watching a short film, etc.). The second group of reward offers may be associated with rewards of a second level (e.g., 10 minutes of network access, watching a longer film, etc.). In some examples, the commitment required for the first group of reward offers may be less than that required for the second group of reward offers.

This description provides examples, and is not intended to limit the scope, applicability, or configuration of embodiments of the principles described herein. Rather, the ensuing description will provide those skilled in the art with an enabling description for implementing embodiments of the principles described herein. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted, or combined. Also, aspects and elements described with respect to certain embodiments may be combined in various other embodiments. It should also be appreciated that the following systems, methods, devices, and software may individually or collectively be components of a larger system, wherein other procedures may take precedence over or otherwise modify their application.

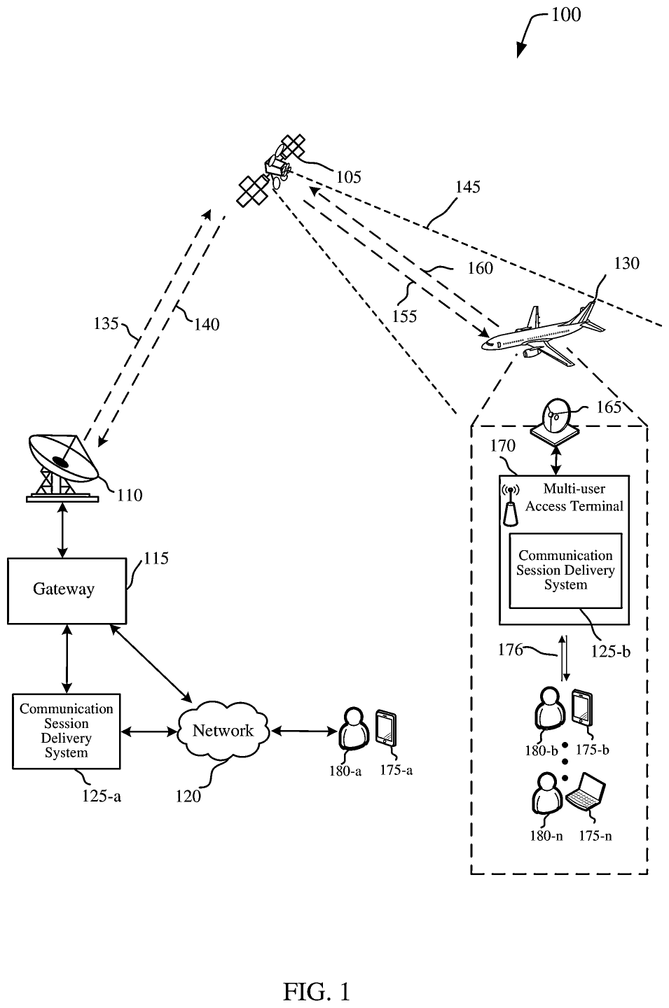

FIG. 1 is a simplified diagram of a satellite communications system 100 in which the principles included herein may be described. The satellite communications system 100 may provide network access service to passengers 180 on-board transport vessel 130 (also referred to as the aircraft 130 herein). It should be noted that although the network access service is illustrated as being provided by a satellite communication system and used as examples in the description that follows, other and/or additional types of communication systems (e.g., an air-to-ground communication system, etc.) may be used in other examples. The network access service may be provided to passengers 180 via a multi-user access terminal 170, to which passengers 180 may connect their communication devices (e.g., the mobile devices 175) via wired (e.g., Ethernet) or wireless (e.g., WLAN) connections 176. Multi-user access terminal 170 may obtain the network access service via a user beam 145. It should be noted that although transport vessel 130 is illustrated as an aircraft and aircraft are used as examples in the description that follows, references to aircraft may also be any type of transport vessel transporting multiple passengers such as buses, trains, ships, etc.

Satellite communications system 100 may include any suitable type of satellite system, including a geostationary orbit (GEO), medium earth orbit (MEO), or low earth orbit (LEO) satellite system. Although only a single user beam 145 is illustrated, satellite 105 may be a multi-beam satellite, transmitting a number (e.g., typically 20-500, etc.) of user beams 145 each directed at a different region of the earth. This can allow coverage of a relatively large geographical area and frequency re-use within the covered area. Frequency re-use in multi-beam satellite systems permits an increase in capacity of the system for a given system bandwidth. With such a multi-beam satellite, there may be a number of different signal switching configurations, allowing signals from a single gateway system 115 to be switched between different spot beams. Alternatively, multiple gateways may transmit signals to satellite 105 for generating the multiple spot beams. Although illustrated as including one satellite 105, satellite communications system 100 may include multiple satellites. The multiple satellites may have service coverage areas that at least partially overlap with each other.

Each satellite user beam 145 of satellite 105 supports aircraft 130 within its coverage area (e.g., providing uplink and downlink resources). Frequency re-use between satellite user beams 145 may be provided by assigning one, or more, ranges of frequencies (which may be referred to as channels) to each satellite user beam 145 and/or by use of orthogonal polarizations. A particular frequency range and/or polarization may be called a “color,” and frequency re-use in a tiled spot beam satellite system may be according to color. The coverage of different satellite user beams 145 may be non-overlapping or have varying measures of overlap. In some examples, satellite user beams 145 of satellite 105 may be tiled and partially overlapping to provide complete or almost complete coverage for a relatively large geographical area where partially overlapping or adjacent beams use different ranges of frequencies and/or polarizations (e.g., different colors).

Satellite communications system 100 includes a gateway system 115 and a network 120, which may be connected together via one or more wired or wireless links. Gateway system 115 is configured to communicate with one or more aircraft 130 via satellite 105. Network 120 may include any suitable public or private networks and may be connected to other communications networks such as the Internet, telephony networks (e.g., Public Switched Telephone Network (PSTN), etc.), and the like. Network 120 may connect gateway system 115 with other gateway systems, which may also be in communication with satellite 105. Alternatively, a separate network linking gateways and other nodes may be employed to cooperatively service user traffic. Gateway system 115 may also be configured to receive return link signals from aircraft 130 (via the satellite 105) that are directed to a destination in network 120 or the other communication networks.

Gateway system 115 may be a device or system that provides an interface between network 120 and satellite 105. Gateway system 115 may use an antenna 110 to transmit signals to and receive signals from satellite 105 via a gateway uplink 135 and a gateway downlink 140. Antenna 110 may be two-way capable and designed with adequate transmit power and receive sensitivity to communicate reliably with satellite 105. In some examples, satellite 105 is configured to receive signals from antenna 110 within a specified frequency band and specific polarization.

In satellite communication system 100, passengers 180-b to 180-n may utilize network access service via mobile devices 175. Each passenger 180-b to 180-n may be provided service via satellite communication system 100 by connecting (e.g., via a wired or wireless connection) a mobile device 175 (e.g., desktop computer, laptop, set-top box, smartphone, tablet, Internet-enabled television, and the like) to the multi-user access terminal 170. As illustrated in FIG. 1, mobile devices 175-b to 175-n are connected via wired or wireless connections 176 (e.g., Wi-Fi, Ethernet, etc.) to multi-user access terminal 170. Multi-user access terminal 170 may receive data from satellite 105 via user beam downlink 155 and transmit data to satellite 105 via user beam uplink 160. While satellite communication system 100 is illustrated providing mobile network access service to passengers 180 aboard aircraft 130, it can be appreciated that the principles described herein for providing network access service to mobile users may be provided using multi-user access terminals positioned in fixed locations or on various modes of transportation where multiple mobile users may desire network access via satellite communications system 100 (e.g., trains, boats, buses, etc.).

Multi-user access terminal 170 may use an antenna 165 mounted on aircraft 130 to communicate signals with satellite 105 via a user beam downlink 155 and user beam uplink 160. Antenna 165 may be mounted to an elevation and azimuth gimbal which points antenna 165 (e.g., actively tracking) at satellite 105. Satellite communications system 100 may operate in the International Telecommunications Union (ITU) Ku, K, or Ka-bands (for example from 17.7 to 21.2 Giga-Hertz (GHz) in the downlink and 27.5 to 31 GHz in the uplink portion of the Ka-band). Alternatively, satellite communications system 100 may operate in other frequency bands such as C-band, X-band, S-band, L-band, and the like.

Satellite communications system 100 also includes a communication session delivery system 125. A component of communication session delivery system 125 (e.g., communication session delivery system 125-a) may be connected via one or more wired or wireless links to gateway system 115 and/or network 120. Additionally, or alternatively, there may be a component of communication session delivery system 125 (e.g., communication session delivery system 125-b) on-board aircraft 130. Although illustrated as being collocated with multi-user access terminal 170, communication session delivery system 125-b may be a separate component from multi-user access terminal 170. In that case, communication session delivery system 125-b may be connected via one or more wired or wireless links to multi-user access terminal 170.

It should be appreciated by a person skilled in the art that one or more aspects of the disclosure may be implemented in a system 100 to additionally or alternatively solve other problems than those described herein. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

In one example, prior to and/or during a travel segment, a travel provider (e.g., airline, cruise line, railway line, bus line) or other entity may provide profile information of one or more passengers 180 of the travel segment to communication session delivery system 125. Additionally, the communication session delivery system 125 may identify a first group of reward offers from a plurality of reward offers to present to passengers 180 of the travel segment, where the reward offers may include a communication session or other reward in exchange for a passenger 180 completing a brand interaction. The reward offers may be provided to communication session delivery system 125 by one or more brand partners. A portal (or other type of user interface) managed by (or otherwise in communication with) communication session delivery system 125 may then present a variety of selected reward offers to a passenger 180. Communication session delivery system 125 may select the first group of one or more reward offers based on, for example, the profile information of the one or more passengers 180 and/or on target characteristics specified by the brand partners, previous brand interactions between the one or more passengers 180 and the brand partners, the current travel segment, a time remaining in the travel segment, or the like. A passenger 180 may access the user interface before or during the travel segment and may choose a reward offer from the first group of one or more reward offers.

For example, passenger 180-a may access the user interface prior to the travel segment using a mobile device 175-a and connecting to network 120 through a terrestrial access point. Upon being provided a first group of one or more reward offers on the user interface, passenger 180-a may select an offer good for a certain communication session in exchange for performing a brand interaction with the offer. Once the brand interaction has been verified, communication session delivery system 125-a may enable passenger 180-a to access a communication session when he or she is aboard aircraft 130. Communication session delivery system 125-a may then provide a second group of one or more reward offers to the user interface. The second group of reward offers may not include the selected reward offer from the first group of reward offers. In some examples, the group of reward offers may not include any type of reward offers that is the same type as the selected reward offer from the first group. Passenger 180-a may be presented one or more first groups of reward offers while connected to communication session delivery system 125-a via a terrestrial network such as network 120 (e.g., prior to boarding the aircraft 130), and may be presented one or more second groups of reward offers while connected to communication session delivery system 125-b (e.g., while on-board the aircraft 130). The first groups of reward offers presented while connected to communication session delivery system 125-a via the terrestrial network may be different from the second groups of reward offers presented while on-board the aircraft and connected to communication session delivery system 125-b. For example, some types of reward offers (e.g., reward offer types that involve a high bandwidth such as playing a video game) may be present in the first groups but not in the second groups. Additionally, or alternatively, some types of reward offer types may be present in the second groups but not in the first groups.

The manner in which the communication session delivery system 125-a enables the passenger to access the communication session can vary. In some examples, the communication session may be attributed to a user account of the passenger managed by the communication session delivery system. In such a case, the passenger may choose when to use the communication session, such as on the current travel segment and/or on different travel segments (e.g., on the same or different airlines or other transportation providers). In other examples, the communication session may be attributed to the communication device used by the passenger without requiring the passenger create a user account.

The manner in which the communication session delivery system 125-a enables the passenger to use the communication session can vary. For example, the communication session delivery system 125-a may provide instructions to components of the satellite communications system 100 (e.g., multi-access user terminal 170, satellite 105, gateway system 115, etc.) to provision access to network 120 to provide the communication session to a communication device associated with the passenger. Passengers 180-b through 180-n on-board aircraft 130 may access the user interface prior to or during the travel segment via multi-user access terminal 170. The portal may be managed by communication session delivery system 125-b on-board aircraft 130 or by communication session delivery system 125-a outside aircraft 130.

Upon viewing of selected offers, passengers 180-b through 180-n may select an offer good for a certain communication session in exchange for performing a brand interaction. Once the brand interaction has been verified, communication session delivery system 125 may enable a respective passenger 180 to access the communication session during the travel segment. For example, communication session delivery system 125-b may maintain a list (e.g., an allow list) of devices that may be allowed to communicate to other devices or networks connected to network 120 (e.g., the Internet) and the associated durations of the communication sessions. Multi-user access terminal 170 may query the list to filter traffic coming from or going to the mobile devices. For example, multi-user access terminal 170 may maintain a network address translation table, and only devices on the list may be provided network address translation for access to networks outside of aircraft 130. Multi-user access terminal 170 may include a firewall (not shown) that prevents devices not on the list from being provided network address translation or prevents devices that have an associated allow list from accessing address not on the allow list. Communication session delivery system 125-b may indicate to communication session delivery system 125-b the identifiers (e.g., MAC addresses) of mobile devices 175 which have been granted communication sessions, which may then provide the information to multi-user access terminal 170.

In some examples, the first group of reward offers may include reward offers that have a first level of engagement associated with a first difficulty level, time commitment, or effort. Once a passenger 180 has selected a reward offer from the first group, communication session delivery system 125-b may present a second group of reward offers. The second group of reward offers may include reward offers that have a second level of engagement associated with a second difficulty level, time commitment, or effort, wherein the second level of engagement is greater than the first level of engagement. In some examples, the first and second groups may include reward offers of multiple different types. The second group of reward offers may maintain some of the same reward offers as the first group, but may include less (e.g., proportionally) reward offers of types associated with reward offers that have been selected from the first group.

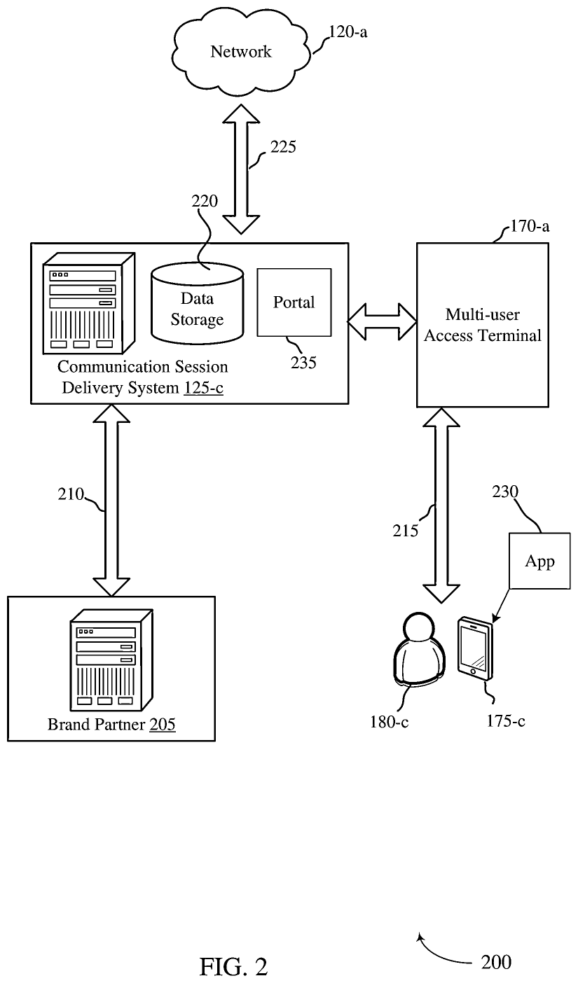

FIG. 2 illustrates an example of a system 200 that supports techniques for providing in-flight communication sessions in accordance with aspects of the present disclosure. System 200 includes communication session delivery system 125-c, brand partner 205, network 120-a, multi-user access terminal 170-a, and mobile device 175-c operated by passenger 180-c. Brand partner 205 and communication session delivery system 125-c may include or utilize various computing components such as data servers and/or data storage systems for facilitating and maintaining communications and supporting offers to facilitate brand interactions and other services. Brand partner 205 may also represent a plurality of affiliated or non-affiliated brand partners. Communication session delivery system 125-c may be an example of a communication session delivery system 125 of FIG. 1. Mobile device 175-c and passenger 180-c may be examples of mobile device 175 and passenger 180 of FIG. 1, respectively.

The entities of system 200 transmit various communication messages between each other, including bidirectional communication 210, bidirectional communication 215, and bidirectional communication 225. For example, bidirectional communication 210 may include brand partner 205 sending one or more reward offers to communication session delivery system 125-c for eventual presentation to passenger 180-c. Each of the reward offers may be linked to one or more target characteristics that a brand partner may wish to focus its reward offer towards. For example, if the reward offer is tailored to a specific gender, a brand partner may indicate that the reward offer's target characteristic is either male or female. In some examples, communication session delivery system 125-c may retrieve reward offers from data storage 220 or from network 120-a via bidirectional communication 225.

A reward offer may include a communication session that is awarded to a passenger when the passenger completes a specified brand interaction. A communication session may be network access service for at least a portion of the travel segment, access to a media content item (e.g., visual media, audio media, games, etc.), or a combination thereof. Access to media content items may also be referred to as in-flight entertainment (IFE). IFE may be hosted on the aircraft and may include content that is otherwise unavailable (e.g., pre-release movies that have not yet become available for streaming) Brand interactions may be categorized as a media item (e.g., displayed advertisement, promotional video), a social media interaction (e.g., a post mentioning the brand), a creation of a user account, a purchase of a good or service, a completion of a survey, a reservation of a good or service, an indication of interest in a good or service (e.g., submitting a positive feedback of the good or service, placing the good or service in a virtual cart, etc.), a purchase of a good or service, providing an email address, trying out a product or service, browsing a brand partner's website, downloading or engaging with an application, or a combination thereof.

Communication session delivery system 125-c may receive profile information of one or more passengers and/or of a travel segment from network 120-a via bidirectional communication 225 or from data storage 220. In some examples, a travel provider of the travel segment may update communication session delivery system 125-c with the passengers' profile information either periodically or aperiodically via bidirectional communication 225. The profile information may include any information that the travel provider may possess regarding a passenger and characteristics of the travel segment that the passenger is booked for. For example, the profile information may include user characteristics such as gender, age, originating/destination location, type of traveler (business, pleasure, etc.), frequency of travel, traveling with a family or group, class of travel for a passenger, previous brand interactions, etc. In another example, the characteristics of the travel segment may include an origin of the travel segment, a destination of the travel segment, respective passenger classes for passengers, a duration of the travel segment, or a type of vessel for the travel segment.

System 200 may include a multi-user access terminal 170-a, which may be an example of the multi-user access terminal 170 of FIG. 1. Multi-user access terminal 170-a may be located on an aircraft and may allow mobile devices 175 to establish communication sessions via a communication link from the aircraft to a ground station (e.g., via a satellite communication system as described in FIG. 1).

Communication session delivery system 125-c may include portal 235, which may be an initial landing page for mobile devices 175 that establish a communication session with multi-user access terminal 170-a. For example, a mobile device 175-c may establish a communication session with multi-user access terminal 170-a (e.g., via a Wi-Fi access point), and multi-user access terminal 170-a may restrict the communication session to have access to only portal 235 (e.g., using an allow list). Portal 235 may be located on the aircraft (e.g., hosted by multi-user access terminal 170-a), or may be located within a ground system of communication session delivery system 125-c. Thus, when mobile device 175-c initially establishes a connection with multi-user access terminal 170-a, mobile device 175-c may be directed to retrieve initial content to display to passenger 180-c from portal 235.

Communication session delivery system 125-c may aggregate the one or more reward offers from brand partner 205 with other reward offers from other brand partners to obtain a pool of reward offers for the travel segment. In some cases, communication session delivery system 125-c may apply a scarcity factor to the pool of reward offers (e.g., may determine the pool of reward offers based on the scarcity factor). Communication session delivery system 125-c may apply a scarcity factor to the pool of reward offers in order to introduce an artificial limitation upon the pool of reward offers on a per-passenger basis. This artificial limitation of the pool of reward offers may be utilized to induce competition or feelings of scarcity for reward offers, which may result in heightened urgency for passengers 180 in claiming reward offers. The scarcity factor may involve limiting the supply of the reward offers (e.g., such that a passenger may not be able to obtain enough reward offers to obtain communication sessions lasting the duration of the flight), limiting the amount of time a reward offer is available, or similar techniques for introducing urgency. In some examples, the scarcity factor may apply to reward offer types, such that easier reward offer types (e.g., those with lower levels of engagement) may become scarcer as the passenger uses reward offers.

In some cases, communication session delivery system 125-c may determine the scarcity factor based on one or more known or expected characteristics (e.g., quantity of passengers, duration of travel segment, aggregate number of access minutes, etc.) of the travel segment when selecting the pool of rewards offers or the first, second, or later groups of reward offers. For example, the scarcity factor may be chosen such that the number of reward offers in the pool is proportional to the total number of passengers on the travel segment (e.g., if one hundred passengers are expected for a travel segment, communication session delivery system 125-c may only offer the number of communication sessions equal to half (or some other multiple) of the quantity of passengers). In another example, communication session delivery system 125-c may only offer a predetermined amount of time corresponding to the pool of rewards. In some examples, communication session delivery system 125-c may also determine the scarcity factor by factoring a total duration of a travel segment and/or a quantity of passengers of the travel segment. For example, communication session delivery system 125-c may only offer 1000 aggregate minutes of network access to all passengers for the travel segment, where the aircraft may have 100 passengers for the travel segment and the travel segment may be one hour long. That is, communication session delivery system 125-c may determine a total number of passenger minutes based on the quantity of passengers (e.g., a passenger capacity of the aircraft or a quantity of booked passengers) and the duration of the travel segment (e.g., gate-to-gate duration, flight duration, or duration of communications taking into account device restrictions during the flight). Communication session delivery system 125-c may then determine the aggregate minutes of network access to be offered based on the total number of passenger minutes and a scarcity factor. A value of the scarcity factor applied to the reward offers may be presented to the passengers along with the associated reward offers. Application of the scarcity factor may better encourage passengers of the travel segment to engage with reward offers than if the reward offers were offered without restrictions. For example, passengers may be encouraged to engage with reward offers earlier, before the available offers are taken by other passengers or removed from the group of reward offers presented to the passenger.

With the profile information, communication session delivery system 125-c may select a first group from the pool of reward offers, where the first group may be a subset of the one or more reward offers from the pool of reward offers. Communication session delivery system 125-c may select the first group of reward offers as being tailored to a particular passenger or group of passengers of a travel segment (e.g., passenger 180-c). Communication session delivery system 125-c may choose the first group of reward offers based on the profile information of the particular passenger or group of passengers, and/or a characteristic of the particular travel segment. In some cases, communication session delivery system 125-c may determine a quantity of reward offers it will select and present to passenger 180-c based on a predetermined number, a quantity of passengers on a travel segment, a duration of the travel segment, or a maximum number of reward offers for the passengers of the travel segment. Communication session delivery system 125-c may choose a second group of reward offers based on any of the factors with which the first group is chosen and also factors including which reward offers the passenger 180-c previously selected (either on this travel segment or on other travel segments).

The one or more reward offers from brand partner 205 may each include a bid associated with the communication session. The bids may indicate a reward offer arrangement which describes a value (e.g., monetary value) that brand partner 205 may confer if its respective reward offer is selected and completed by a passenger. In some cases, communication session delivery system 125-c may select the pool of reward offers based on the bids. For example, communication session delivery system 125-c may select those rewards with the highest bids, or the rewards with the highest bids within categories of reward offers (e.g., associated with different types of brand interactions). In some examples, communication session delivery system 125-c may select a certain quantity of reward offers to be available for each of multiple types of brand interactions, and then select the rewards with the highest bids for each type.

Upon selection of the first group of reward offers, communication session delivery system 125-c may transmit the first group of reward offers over bidirectional communication 215 to a device belonging to passenger 180-c (e.g., mobile device 175-c). The first group of reward offers may be presented to the passenger 180-c via a portal 235 hosted by communication session delivery system 125-c or application 230 on mobile device 175-c. Passenger 180-c may view the first group of reward offers through the portal 235 or application 230 on mobile device 175-c either prior or during the travel segment. In some examples, mobile device 175-c may be a seat-mounted video system on board the aircraft.

Passenger 180-c may choose one or more reward offers from the first group of reward offers and may then proceed to complete a brand interaction associated with the chosen reward offer. In some examples, passenger 180-c may request that the presented first group of reward offers be changed or otherwise modified. A benefit of allowing passenger 180-c to request that the presented first group of reward offers be changed is that a first presented subset of reward offers may be unsatisfactory to passenger 180-c. Allowing modification to the first presented group of reward offers may allow passenger 180-c to discover a reward offer from a subsequent subset of reward offers (with the subsequent subset of reward offers having at least one changed presented reward offer from the first presented subset of reward offers) that may appeal to passenger 180-c. Upon receiving the request, communication session delivery system 125-c may provide a modified first group of reward offers to passenger 180-c, where the modified first group of reward offers is different from the previous subset of reward offers. Further, the second group of reward offers presented to passenger 180-c may include a different subset of reward offers which may be selected based at least in part on the first group of reward offers, a selected reward offer, and any changes requested by passenger 180-c.

When passenger 180-c selects a reward offer, mobile device 175-c may transmit an indication of the selected reward offer to communication session delivery system 125-c via bidirectional communication 215. Performance of the brand interaction may then occur via communication session delivery system 125-c, via the respective brand partner 205, or via a third entity (e.g., media server). For example, communication session delivery system 125-c may forward session information associated with the passenger-selected reward offer to a respective brand partner 205 via bidirectional communication 210. Brand partner 205 may monitor various brand interactions and then verify when a brand interaction associated with the session information has occurred or is complete.

Upon the verification, brand partner 205 may indicate to communication session delivery system 125-c via bidirectional communication 210 that the brand interaction associated with the session information has occurred. In another example, a passenger 180-c with mobile device 175-c may interact directly with brand partner 205 or with a third entity hosting the brand interaction for brand partner 205. Passenger 180-c may complete a brand interaction in direct communication with brand partner 205 or the third entity, and upon completion of the brand interaction, brand partner 205 may indicate to communication session delivery system 125-c to provide communication session access to passenger 180-c.

In some examples, communication session delivery system 125-c may provide a unique identifier associated with passenger 180-c or mobile device 175-c to brand partner 205 or other outside parties in order to enable brand partner 205 or the outside parties to authorize and link the reward to passenger 180-c and/or mobile device 175-c. For example, the unique identifier may be generated based on an identifier associated with passenger 180-c or mobile device 175-c, but that is not traceable by brand partner 205 or other entities to passenger 180-c or mobile device 175-c. In one example, the unique identifier is based on (e.g., hashed or encrypted) the media access control (MAC) address of mobile device 175-c. Upon receiving confirmation that the brand interaction has been completed, communication session delivery system 125-c may associate mobile device 175-c with the reward associated with the reward offer. In some examples, communication session delivery system 125-c may receive an indication of completion of the brand interaction by receiving an indication that an amount of data transferred as part of the first brand interaction exceeds a data transfer threshold. For example, communication session delivery system 125-c may associate the MAC address of mobile device 175-c with access to a session of a duration associated with the reward. In other examples, communication session delivery system 125-c may present a redemption code to passenger 180-c upon completion of a brand interaction where passenger 180-c may redeem the redemption code at a later time (e.g., via the same or a different device) for access to a communication session.

Upon receiving the indication, redemption code, or another indication of access, communication session delivery system 125-c may activate access to passenger 180-c to the associated reward (e.g., communication session or media experience) linked to the passenger-selected reward offer. For example, communication session delivery system 125-c may establish a communication session for mobile device 175-c via a network access device (e.g., multi-user access terminal 170) over a wireless communications link for a session duration associated with the reward offer. In some examples, communication session delivery system 125-c may determine an identifier of a device (e.g., MAC address) that is linked to the completed brand interaction and establish the communication session based on the identifier of the device. Under some circumstances, communication session delivery system 125-c may determine a duration of the reward and then present to mobile device 175-c a comparison of the duration to a length of time of the travel segment, where the comparison may be continually updated and presented. For example, if the reward is one hour of network access time and the remaining duration of the travel segment is two hours, mobile device 175-c may continually provide the comparison to passenger 180-c when passenger 180-c views application 230 or portal 235.

In some examples, communication session delivery system 125-c may receive a unique identifier linked to passenger 180-c. For example, passenger 180-c may have registered a login profile with portal 235 of communication session delivery system 125-c. In some cases, passenger 180-c may complete multiple brand interactions associated with multiple reward offers and communication session delivery system 125-c may link the multiple reward offers to the unique identifier of passenger 180-c. For example, if passenger 180-c has logged on and completed five brand interactions each worth 10 minutes of network access time, communication session delivery system 125-c may link 50 minutes of network access time to the user account of passenger 180-c. In other examples, communication session delivery system 125-c may identify one or more past brand interactions that passenger 180-c has performed under his or her unique identifier. With these past completed brand interactions, communication session delivery system 125-c may select reward offers from the pool of reward offers for a given travel segment to present to passenger 180-c based on the brand interaction history of passenger 180-c.

Communication session delivery system 125-c may also include data storage 220. In some examples, data storage 220 may receive and store verified completions of brand interactions for a particular travel segment. In a subsequent travel segment, communication session delivery system 125-c may receive reward offers from brand partner 205 or from other brand partners for the subsequent travel segment in a similar manner as described above. In some examples, communication session delivery system 125-c may choose the pool of reward offers for the subsequent travel segment based at least in part on the stored verified completions of brand interactions from a previous travel segment. Communication session delivery system 125-c may also choose respective first and second groups of the pool of reward offers for the subsequent travel segment based on profile information of the passengers of the subsequent travel segment. The profile information may similar profile information described above. The verified completions of brand interactions from the previous travel segment may better inform communication session delivery system 125-c as to which reward offers have been successful in the past.

In some examples, communication session delivery system 125-c may store verified completions of brand interactions of a particular passenger (e.g., passenger 180-c) in data storage 220. This data may be linked to a user account of passenger 180-c or a unique identifier associated with a device of passenger 180-c (e.g., a MAC address). In some cases, communication session delivery system 125-c may use the verified completions of brand interactions of passenger 180-c to inform the selection of a first group of reward offers that are to be presented to passenger 180-c. In other examples, communication session delivery system 125-c may use the verified completions of brand interactions of passenger 180-c to exclude reward offers from being presented to passenger 180-c in a subset of reward offers. For example, excluded reward offers may be types of brand interactions that passenger 180-c has already completed or types of media experiences that passenger 180-c has already consumed (e.g., already viewed certain brand content). Additionally, communication session delivery system 125-c may utilize stored verified completions of brand interactions to determine trends for similar travel segments and use the determinations to select future reward offers for passengers on future similar travel segments. For example, travel segments with similar characteristics such as time of day, origin, destination, etc., may inform communication session delivery system 125-c on selections of future reward offers to present on similar travel segments.

In another example, communication session delivery system 125-c may determine categories for each reward offer that it receives. Communication session delivery system 125-c may further determine categories of reward offers that passenger 180-c has selected in the past and then select a first or second group of reward offers to present to passenger 180-c based on which categories of reward offers that passenger 180-c has previously selected. For example, if passenger 180-c has selected previous reward offers involving social media posts, communication session delivery system 125-c may present more reward offers that involve completing social media posts to passenger 180-c. In some cases, communication session delivery system 125-c may exclude presenting certain categories of reward offers that passenger 180-c has shown a lack of engagement with. For example, if passenger 180-c has never selected previous reward offers involving purchasing goods or services, communication session delivery system 125-c may exclude presenting reward offers that involve the purchase of goods and services.

In some cases, communication session delivery system 125-c may identify from data storage 220 how a particular type of passenger has interacted with a certain reward offer. For example, the interaction history data may indicate if the passenger viewed the offer and did not accept the offer, if the passenger viewed the offer and did accept the offer, if the viewer viewed the offer and attempted the brand interaction unsuccessfully, if the viewer viewed the offer and attempted the brand interaction successfully, etc. Communication session delivery system 125-c may use the interaction history data and associated passenger profile information to inform which reward offers from brand partner 205 to select and present to passengers.

In another example, communication session delivery system 125-c may determine a metric from the prior interactions of passenger 180-c with the reward offers. These metrics may be a completion rate of the one or more of the plurality of reward offers (e.g., a rate at which passengers complete the brand interaction once they have selected it), a number of impressions for the one or more of the plurality of reward offers, a number of passenger selections of the one or more of the plurality of reward offers, a number of media initiations associated with the one or more of the plurality of reward offers (e.g., a number of times that viewing a media item associated with a reward offer has been started), a number of media completions associated with the one or more of the plurality of reward offers (e.g., a number of times that viewing a media item associated with a reward offer has been completed), or a combination of these metrics. Communication session delivery system 125-c may deliver one or more of these metrics to brand partner 205 over bidirectional communication 210.

Communication session delivery system 125-c may also possess additional features. For example, aggregate rewards may be split between multiple devices (e.g., a user account may be accessed from multiple devices). Some entertainment features may be tailored specifically for children. The reward offers may include IFE (e.g., content such as visual media, audio media, games), and passenger 180-c may consume this content on his or her personal device during the travel segment. A reward offer may also provide access to a moving map which may illustrate where a vessel is geographically on the travel segment. A reward offer may also be presented as a gift to an acquaintance of passenger 180-c. Additionally, passenger 180-c may refer the acquaintance and earn bonus time of network access or access to media content (e.g., IFE).

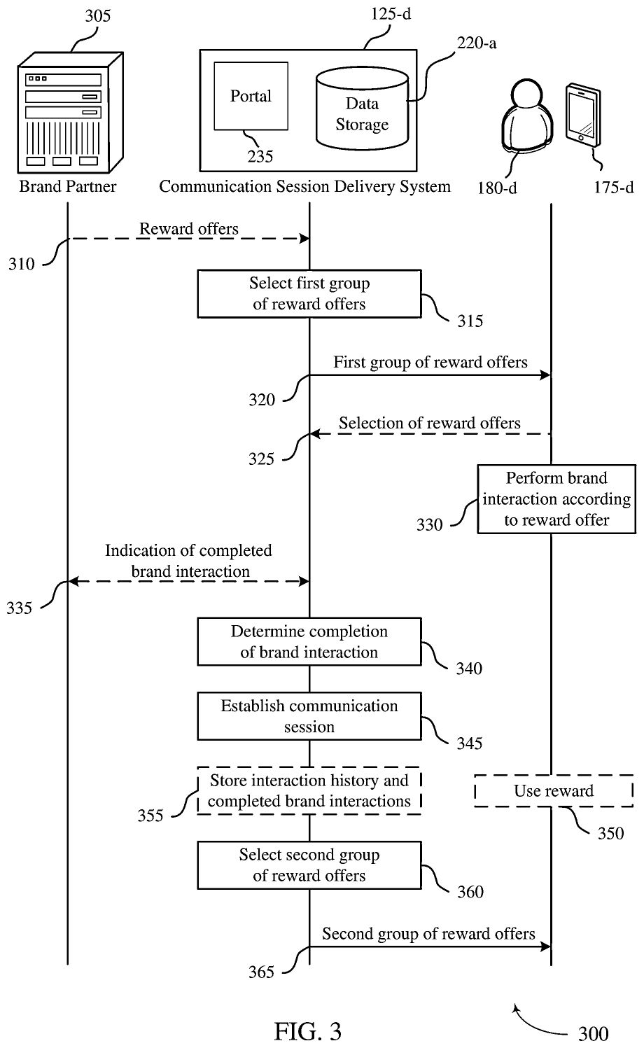

FIG. 3 illustrates an example of a process flow 300 that supports techniques for user-level reward offer interface and management in accordance with aspects of the present disclosure. Process flow 300 may include communication session delivery system 125-d, brand partner 305, and mobile device 175-d operated by passenger 180-d. Communication session delivery system 125-d may be an example of a communication session delivery system 125 of FIG. 1 or of communication session delivery system 125-c of FIG. 2. Brand partner 305 may be an example of brand partner 205 of FIG. 2. Examples may include more than one brand partner 305, but for illustrative purposes, a single brand partner 305 is described in FIG. 3. Mobile device 175-d and passenger 180-d may be examples of mobile device 175 and passenger 180 of FIG. 1 and of mobile device 175-c and passenger 180-c of FIG. 2, respectively.

At 310, communication session delivery system 125-d may receive reward offers from brand partners 305 for eventual presentation to passenger 180-d, for example, on mobile device 175-d. Each of the reward offers may be linked to one or more target characteristics that brand partner 305 may wish to focus its reward offer towards. Reward offers may include individual reward offers. Each reward offer may include a brand interaction and a reward. As received from a brand partner 305, the reward may be expressed in a currency (e.g., USD), and the communication session delivery system 125-d may translate the reward into a communication experience (e.g., minutes for a communication session, media experience, etc.) for presentation to passengers 180. In some examples, communication session delivery system 125-d may retrieve reward offers from data storage 220-a or from another external entity. The reward offers may comprise the pool of reward offers.

At 315, communication session delivery system 125-d may select a first group of reward offers. The first group of reward offers may be selected based on one or more factors or characteristics. For example, communication session delivery system 125-d may evaluate profile information for a travel segment and select the first group of reward offers for the travel segment. For example, communication session delivery system 125-d may evaluate profile information of the passengers and characteristics of the travel segment to select the first group of reward offers. The first group of reward offers may have a scarcity factor relative to a number of passengers (e.g., capacity or booked passengers) and duration of the travel segment as described above. In some examples, the first group of reward offers may have an aggregate reward time for the communication session that exceeds a duration of the travel segment (e.g., or a time in which the communication session is available based on altitude restrictions). In some cases, each group of reward offers of respective reward offer types may have an aggregate reward time for the communication session that has a scarcity factor relative to the duration of the travel segment. That is, to enjoy continuous connectivity over the travel segment, the passenger may have to select reward offers of more than one reward offer type. Communication session delivery system 125-d may receive profile information of one or more passengers and/or of a travel segment from data storage 220-a or from a travel provider. In some examples, communication session delivery system 125-d may select the first group of reward offers that is tailored to a passenger (e.g., passenger 180-d) or group of passengers for an upcoming travel segment.

Communication session delivery system 125-d may choose the first group of reward offers based on the profile information of passenger 180-d and/or a characteristic of the upcoming travel segment. In some examples, communication session delivery system 125-d may select the first group of reward offers for a group of passengers of a travel segment. Communication session delivery system 125-d may select additional groups of reward offers for additional passengers or groups of passengers. For example, some of the first groups of reward offers for different passengers or groups of passengers may include some of the same reward offers (e.g., they may be partially overlapping subsets). If a reward offer is selected by a passenger, in some cases it may be removed from other groups of reward offers in which it appeared.

Communication session delivery system 125-d may exclude reward offers from the first group of reward offers for a passenger based on previous completed brand interactions by the passenger. For example, passenger 180-d may have already performed a brand interaction associated with a reward offer, and thus that reward offer may be excluded from the first group of reward offers. Additionally, or alternatively, communication session delivery system 125-d may categorize the brand interactions of the first group of reward offers, and may select the first group of reward offers based on prior interactions of passenger 180-d. For example, where passenger 180-d has selected certain reward offer types (e.g., media item, a social media interaction, a creation of a user account, a purchase of a good or service, a completion of a survey, a reservation of a good or service, an indication of interest in a good or service, providing an email address, watching a video, browsing a website, etc.) of reward offers for previous travel segments, the first group of reward offers may include offers from those reward offer types and exclude other types for which the passenger has not selected reward offers, or which are different from types they have selected. For example, if passenger 180-d has selected reward offers with brand interactions involving consuming media content such as ads but has not selected brand interactions related to the purchase of goods and services even though presented with a quantity of reward offers in this category greater than a threshold, the first group of reward offers may exclude brand interactions related to the purchase of goods and services.

At 320, communication session delivery system 125-d may transmit the first group of reward offers to mobile device 175-d belonging to passenger 180-d. Passenger 180-d may view the subset of selected reward offers through a portal hosted by communication session delivery system 125-d, or via an application on mobile device 175-d either prior or during the travel segment. Along with being presented with the first group of reward offers, passenger 180-d may be informed that only a quantity of communication sessions is available corresponding to the number of reward offers in the first group of reward offers to be redeemed for the flight segment. Passenger 180-d may be presented with an option to update the first group of reward offers 420 if they do not want to select the reward offers presented to them. Upon requesting update of the first group of reward offers, communication session delivery system 125-d may select a new first group of reward offers from the pool of reward offers. The new first group of reward offers may maintain a same proportion of reward offers of the different reward offer types as the original first group of reward offers.

In some embodiments, the one or more of the presented reward offers may include or otherwise indicate an associated brand interaction. In some embodiments, the associated brand interaction may involve the passenger 180-d providing account information (or similar information) that enables the portal 235-a to verify an existing relationship of the passenger 180-d. In some instances, the passenger 180-d may provide account information to complete the associated brand interaction, which the portal 235-a may use to authorize a reward session based on a relationship, status, etc., of the passenger 180-d, such as one or more of a loyalty status, cell phone plan, home internet plan, and so forth). For example, where the passenger 180-d has a cell phone plan that permits or includes free internet access of aircraft travel, the passenger 180-d may provide corresponding account information that the portal 235-a uses to verify with the cell phone plan provider to authorize such access. Based on authorizing the access permitted to the passenger 180-d, the passenger 180-d may be provided with an unrestricted communication session at 345. Similarly, the portal 235-a may determine whether the passenger 180-d is permitted to access one of a number of restricted or unrestricted communication sessions as may be appropriate with associations with the provided account information (such as time limited access, content limited access, and so forth).

At 325, passenger 180-d may choose one or more reward offers from the first group of reward offers and may then proceed to complete a brand interaction associated with the chosen reward offers. For example, passenger 180-d may select a reward offer from the first group of reward offers. Mobile device 175-d may send an indication of the selected reward offer to communication session delivery system 125-d. In some examples, the selected reward offer may correspond to a selected reward offer type.

At 330, passenger 180-d may proceed to complete a brand interaction associated with the chosen reward offer. Passenger 180-d may complete multiple brand interactions and aggregate the rewards associated with the multiple brand interactions. The brand interaction may include, for example, viewing an advertisement or video, browsing a website associated with the brand partner, purchasing a product or service, downloading an application, or the like.

At 335, communication session delivery system 125-d may receive an indication of completion of one or more brand interactions associated with the selected reward offers. For example, passenger 180-d may complete a brand interaction in direct communication with brand partner 305, and upon completion of the brand interaction, brand partner 305 may indicate to communication session delivery system 125-d to provide communication session access to passenger 180-d. In another example, when passenger 180-d selects a reward offer, mobile device 175-d may transmit an indication of the selected reward offer to communication session delivery system 125-d. Communication session delivery system 125-d may then forward session information associated with the passenger-selected reward offer to brand partner 305. Such session information may include, for example, a time duration of the brand interaction or an amount of data transferred during the brand interaction. Brand partner 305 may monitor various brand interactions and then verify when a brand interaction associated with the session information has occurred. Upon the verification, brand partner 305 may indicate to communication session delivery system 125-d that the brand interaction associated with the session information has occurred.

At 340, communication session delivery system 125-d may determine that the brand interaction has been completed. Either communication session delivery system 125-d determines the brand interaction is completed from the indication of the completed brand interaction from brand partner 305, or communication session delivery system 125-d determines it directly using metrics from the communication session. For example, if the brand interaction is to download an application, communication session delivery system 125-d may determine that an amount of data transfer equal or exceeding the size of the application has been performed. In another example, communication session delivery system 125-d may determine the brand interaction has been completed after a timer has expired, wherein the timer may be set based on the reward offer. For example, if the reward offer indicates a video must be watched for at least 3 minutes, then communication session delivery system 125-d may determine that the brand interaction is complete after 3 minutes of the video playing on mobile device 175-d.

At 345, communication session delivery system 125-d may activate access to passenger 180-d to the associated reward (e.g., communication session or media experience) linked to the passenger-selected reward offer. For example, communication session delivery system 125-d may establish a communication session between mobile device 175-d and other networks via a network access device (e.g., multi-user access terminal 170) over a wireless communications link for a session duration associated with the reward offer. A characteristic of the communication session may be based on the associated reward linked to the passenger-selected offer. In some examples, the characteristic of the communication session may be a total amount of time allotted to the communication session, a data rate of the communication session, a total amount of data communicated for the communication session, access to one or more service types (text, email, streaming), access to one or more network destinations (e.g., Netflix, Amazon), or a combination thereof.

At 355, communication session delivery system 125-d may store passenger interaction history data and completed brand interactions in data storage 220-a. In an example, communication session delivery system 125-d may choose to present certain reward offers for a subsequent travel segment informed by the stored verified completions of brand interactions from a previous travel segment. This data may be linked to a user account of passenger 180-d. In some cases, communication session delivery system 125-d may identify from data storage 220-a how a particular type of passenger has interacted with a certain reward offer. Communication session delivery system 125-d may use the interaction history data and associated passenger profile information to inform which reward offers from brand partner 305 to select and present to passengers.

At 350, passenger 180-d may use the reward, which may be a communication session. In some examples, the communication session may be unrestricted access to the Internet. In some examples, passenger 180-d may create a user account with communication session delivery system 125-d and may store and/or visualize completed brand interactions and rewards associated with the user account in an online portal. The aggregated rewards may be redeemed on multiple travel segments. A user application may indicate to passenger 180-d when the rewards may be redeemed. In some examples, passenger 180-d may purchase additional rewards. In other examples, passenger 180-d may transfer or gift one or more accumulated rewards to another passenger. In some cases, passenger 180-d may persuade another passenger to complete one or more brand interactions and passenger 180-d may earn additional rewards based on the referral.

At 360, communication session delivery system 125-d may select a second group of reward offers from the pool of reward offers. The second group of reward offers may be different from the first group of reward offers. For example, the second group of reward offers may not include the reward offer that passenger 180-d selected at 325. In some examples, a first reward offer type may be associated with a first level of engagement and a second reward offer type may be associated with a second level of engagement. The first level of engagement may be relatively low commitment compared to a second level of engagement, such as involving shorter time durations of brand interactions to receive the reward, purchasing cheaper products or services, providing less user information, and the like. The second group of reward offers may have a lower proportion of the first reward offer type if the selected reward offer is of the first reward offer type. That is, once passenger 180-d has performed a brand interaction for a reward, the next group of offers may include a higher proportion of brand interactions that are somewhat more involved to get an additional reward. At 365, communication session delivery system 125-d may provide the second group of reward offers to mobile device 175-d, similar to at 320.

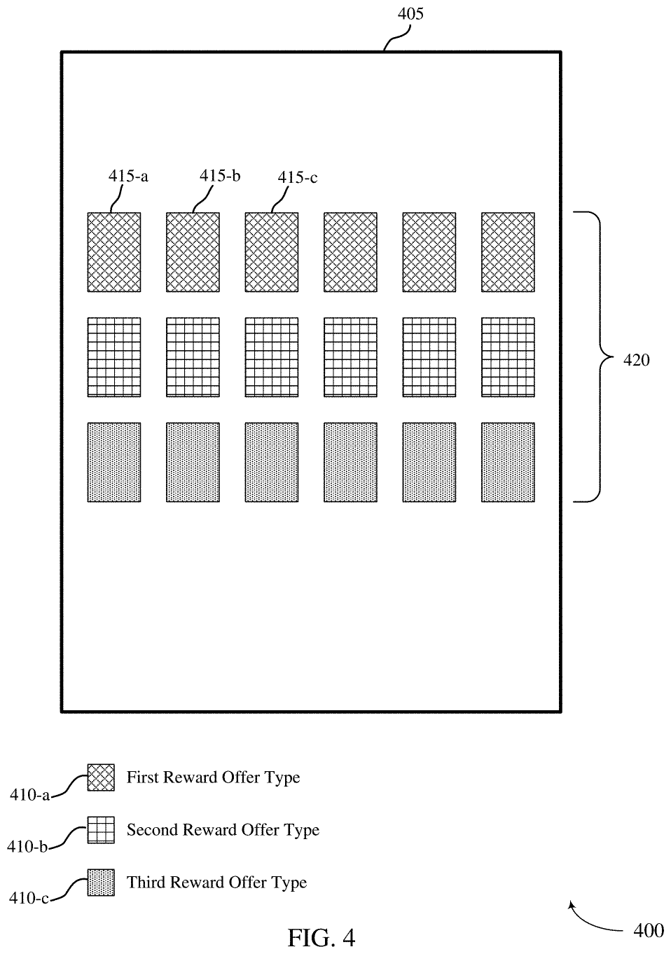

FIG. 4 illustrates an example graphical representation 400 of a session interaction interface 405 that support techniques for user-level reward offer interface and management in accordance with aspects of the present disclosure. In some examples, graphical representation 400 may be output on a mobile device, which may be an example of mobile device 175 of FIGS. 1-3.

Graphical representation 400 shows a first group of reward offers 420 displayed as tiles on a graphical user interface or display. Different reward offers from first group of reward offers 420 may be associated with different reward offer types 410 and may be from one or more brand partners. In this example, first group of reward offers 420 may be associated with three different offer types, represented as reward offer types 410-a, 410-b, and 410-c. The reward offer types may be, for example, watching a video, buying a product or service, signing up for a product or service, trying out a product or service, downloading an application, browsing a website, participating in a personal call or a conference call, or the like.

Each reward offer 415 may include a brand interaction and a reward. Each reward offer 415 may indicate the brand interaction and the reward to the passenger. As received from a brand partner, the reward may be expressed in a currency (e.g., USD), and the communication session delivery system may translate the reward into a communication experience (e.g., minutes for a communication session, media experience, etc.) for presentation to passengers. For example, reward offers 415-a and 415-b may come from or be sponsored by a first brand partner, while reward offer 415-c may come from or be sponsored by a second brand partner. In some examples, first group of reward offers 420 may represent a subset of a total number of reward offers provided by brand partners. The communication session delivery system may have selected first group of reward offers 420 for a particular passenger based on one or more characteristics of the passenger or a travel segment. In another example, a different first group of reward offers 420 may be selected. Furthermore, a different passenger may see the same or different first group of reward offers. In some examples, communication session delivery system may select first group of reward offers 420 for a group of passengers of a travel segment. For example, first group of reward offers 420 may also be selected for another passenger traveling on the same travel segment that the passenger is traveling on.

The communication session delivery system may select additional groups of reward offers for additional passengers or groups of passengers. For example, a subset including reward offers 415-b and 415-c of the third reward offer type 410-c may be selected for a different passenger. As shown in FIG. 4, some subsets of reward offers 415 for different passengers or groups of passengers may include some of the same reward offers 415 (e.g., they may be partially overlapping subsets). If a reward offer 415 is selected by a passenger, it may be removed from other subsets of reward offers 415 in which it appeared.

Reward offers 415 of the first reward offer type 410-a may have a first level of engagement. That is, they may be associated with an amount of time, money, work, or effort to complete the brand interaction and qualify for the reward. Reward offers of the second reward offer type 410-b may have a second level of engagement that is higher than the first level. Reward offers of the third reward offer type 410-c may have a third level of engagement that is higher than the first level and the second level. In some cases, the first level of engagement is associated with a passive engagement such as watching an ad while the second level of engagement or third level of engagement is an active engagement such as interacting with a brand partner website, purchasing a good or service, or downloading an application. The first group of reward offers 420 may have first respective proportions of the reward offer types 410. The passenger may select a reward offer 415 and be connected to the network session in order to complete the brand interaction. If the communication session delivery system determines that the passenger completes the brand interaction (either autonomously or indicated by the brand partner), the communication session delivery system may provide the passenger with the reward. For example, the passenger may select reward offer 415-a of the first reward offer type 410-a.

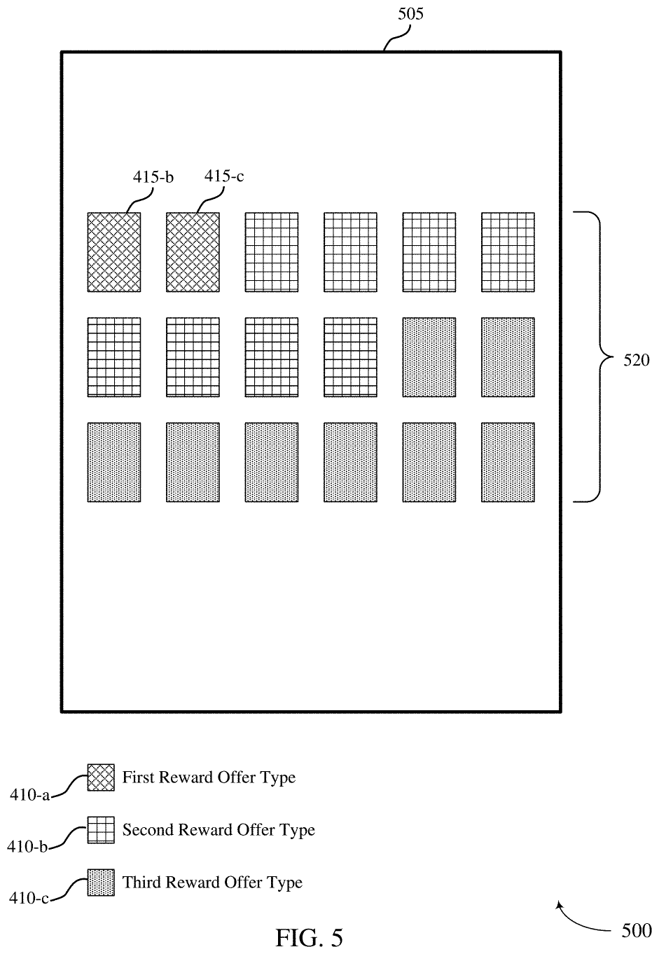

FIG. 5 illustrates an example graphical representation 500 of a session interaction interface 505 that support techniques for user-level reward offer interface and management in accordance with aspects of the present disclosure. In some examples, graphical representation 500 may be output on a mobile device, which may be an example of mobile device 175 of FIGS. 1-3.

Graphical representation 500 shows a second group of reward offers 520 displayed as tiles on a graphical user interface. The reward offers in the second group of reward offers 520 may be associated with different proportions of the reward offer types. In this example, second group of reward offers 520 may be associated with the same three different reward offer types 410-a, 410-b, and 410-c. The offer types may be, for example, watching a video, buying a product or service, signing up for a product or service, trying out a product or service, downloading an application, browsing a website, participating in a personal call or a conference call, or the like.

The communication session delivery system may present second group of reward offers 520 to a passenger after a reward offer 415-a from a first group of reward offers has been accepted, such as in FIG. 4. The reward offer 415-a selected from the first group of reward offers may not be included in second group of reward offers 520. In this example, if the passenger selected a reward offer 415-a from first group of reward offers 420, then less of reward offers associated with the first reward offer type 410-a may be included in second group of reward offers 520. For example, first group of reward offers 420 included six reward offers 415 associated with the first reward offer type 410-a, while second group of reward offers 520 includes only two reward offers 415 associated with the first reward offer type 410-a. In some examples, the second group of reward offers 520 may not include any reward offers 415 of the reward offer type 410 selected from the first group of reward offers 420. In the illustrated example, two more reward offers 415 associated with the second reward offer type 410-b, and two more reward offers 415 associated with the third reward offer type 410-c may be included in second group of reward offers 520. That is, the total quantity of reward offers 415 in the second group of reward offers 520 may be the same as the total quantity of reward offers 415 in the first group of reward offers 420, while a relative proportion of reward offers 415 of the reward offer type selected from the first group of reward offers 420 is reduced (e.g., and relative proportions of one or more other reward offer types is increased).

Although FIG. 5 illustrates that additional reward offers of the first reward offer type 410-a are also excluded (e.g., three other reward offers of the first reward offer type 410-a are also excluded from the second group of reward offers), in some cases the selected reward offer 415 is excluded while the other reward offers of the same type are not excluded (e.g., in this case five reward offers 415 of the first reward offer type 410-a would be included in the second group of reward offers 520). In addition, although FIG. 5 shows that additional reward offers are added such that the total quantity of reward offers 415 in the second group of reward offers 520 is the same as the total quantity of reward offers 415 in the first group of reward offers 420, in some cases the selected reward offer 415 is excluded while no additional reward offers are added. Thus, the total quantity of reward offers 415 in the second group of reward offers 520 may be less than the total quantity of reward offers 415 in the first group of reward offers 420. In either case, a relative proportion of reward offers of the first of reward offer type 410-a is reduced in the second group of reward offers 520.

The passenger may select a reward offer 415 and be connected to the network session in order to complete the brand interaction. If the communication session delivery system determines that the passenger completes the brand interaction (either autonomously or indicated by the brand partner), the communication session delivery system may provide the passenger with the reward.

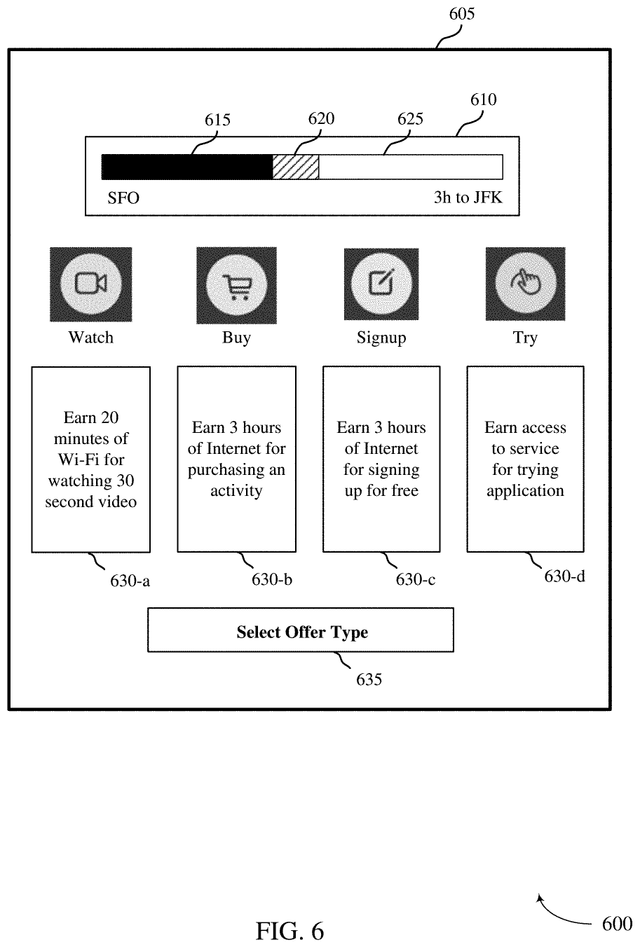

FIG. 6 illustrates an example graphical representation 600 of a session interaction interface 605 that support techniques for user-level reward offer interface and management in accordance with aspects of the present disclosure. In some examples, graphical representation 600 may be output on a mobile device, which may be an example of mobile device 175 of FIGS. 1-3.

Session interaction interface 605 may display a portal (e.g., which may be part of an application on the mobile device, or a portal hosted on a different device) which may in turn interact with a communication session delivery system 125. Passenger 180 may create a user account that communication session delivery system 125 may access. In some examples, passenger 180 may utilize the user account to track one or more rewards that passenger 180 has earned through completing respective brand interactions, purchases, referrals, etc. In some cases, communication session delivery system 125 may aggregate the one or more rewards associated with the user account of passenger 180 and determine an aggregate reward for passenger 180. In some examples, the aggregate reward may comprise rewards that are unused and/or unredeemed by passenger 180. In other examples, communication session delivery system 125 may track the portion of rewards that have been used and/or redeemed by passenger 180. In some examples, the user account may be used to apply rewards across travel segments, or across different airlines or other transportation providers. Thus, rewards may be earned and applied to a user account, and the communication session delivery system 125 may access the rewards for redeeming on any travel segment taken by the passenger 180. For example, aspects of a communication session delivery system 125 on an aircraft may access the user account and redeem rewards for a communication session on the aircraft, tracking the portion used on the travel segment on the aircraft, and leaving any unused portion for future travel segments.

Session interaction interface 605 may display certain visualizations that a passenger 180 may interact with in order to access various communication sessions and media experiences. For example, indicator 610 may display the time already traveled during a travel segment 615, the time left for an established communication session 620 (e.g., the time left from the rewards acquired through the selected reward offers), and the time remaining for the travel segment 625. In some examples, the time left for an established communication session 620 may be an unused portion of the aggregate reward associated with the user account of passenger 180. Indicator 610 may also display textually the time left for an established communication session (e.g., an unused portion of the aggregate reward associated with the user account of passenger 180). Indicator 610 may serve to easily convey to a passenger 180 if their communication session will end before the travel segment ends.

Session interaction interface 605 may display tiles 630 associated with different reward offer types. In the example of FIG. 6, a tile 630-a is associated with the watch offer type, related to watching a video for a reward. Tile 630-b is associated with the buy offer type, related to buying a product, activity, or service for a reward. Tile 630-c is associated with the signup offer type, related to signing up for a product, activity, or service for a reward. Tile 630-d is associated with the try offer type, related to trying a product, service, activity, or application for a reward. In other examples, other offer types may be presented. Additionally, more or less offer types may be displayed in session interaction interface 605. In some cases, the watch offer type may be a first reward offer type associated with a first engagement level, the try offer type may be a second reward offer type associated with a second engagement level, the signup offer type may be a third reward offer type associated with a third engagement level, and the buy offer type may be a fourth reward offer type associated with a fourth engagement level, where the time or money provided by the passenger to fulfil the engagement increases with engagement level.

The tiles 630 may be associated with a group of reward offers, as described herein. If passenger 180 wishes to select an offer type, they may interact with the corresponding tile 630 and toggle a select offer type button 635. In some examples, interacting with the tile 630 would select that offer type.

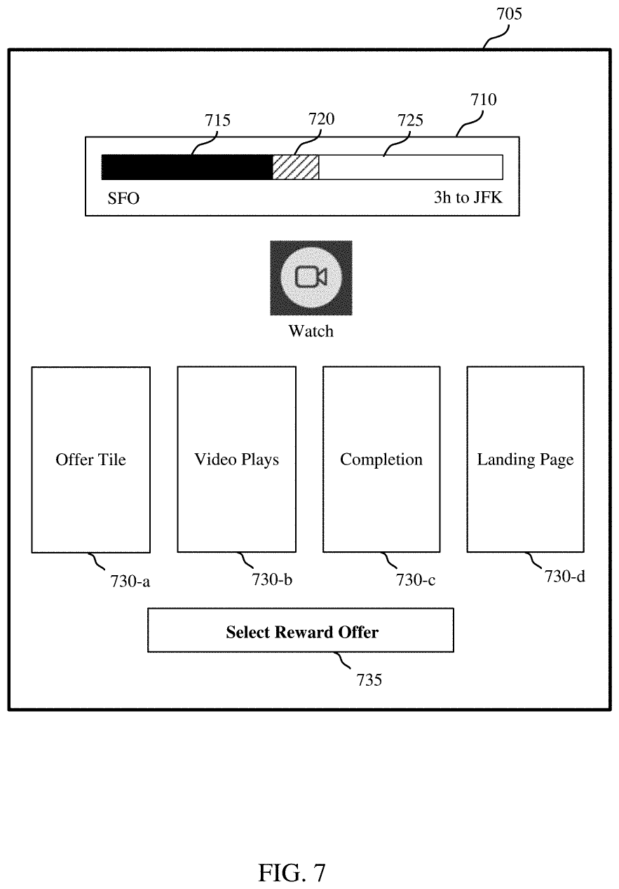

FIG. 7 illustrates an example graphical representation 700 of a session interaction interface 705 that supports techniques for user-level reward offer interface and management in accordance with aspects of the present disclosure. In some examples, graphical representation 700 may be output on a mobile device, which may be an example of mobile device 175 of FIGS. 1-3.

Session interaction interface 705 may display a portal (e.g., which may be part of an application on the mobile device, or a portal hosted on a different device) which may in turn interact with a communication session delivery system 125. Session interaction interface 705 may display certain visualizations that a passenger 180 may interact with in order to access various communication sessions and media experiences. For example, indicator 710 may display the time already traveled during a travel segment 715, the time left for an established communication session 720 (e.g., the time left from the rewards acquired through the selected reward offers), and the time remaining for the travel segment 725. In some examples, the time left for an established communication session 720 may be an unused portion of the aggregate reward associated with the user account of passenger 180. Indicator 710 may also display textually the time left for an established communication session (e.g., an unused portion of the aggregate reward associated with the user account of passenger 180). Indicator 710 may serve to easily convey to passenger 180 if their communication session will end before the travel segment ends.

Session interaction interface 705 may display tiles 730 associated with different reward offers of a specific reward offer type. In the example of FIG. 7, passenger 180 has selected the watch offer type from the example of FIG. 6. A tile 730-a may be an offer tile, which may display reward offers and a summary of the set of reward offers under the watch reward offer type. A tile 730-b may show video plays, including screen size options (e.g., minimized, full screen, etc.), and different video options (e.g., 30 seconds, 60 seconds, 120 seconds, etc.). A tile 730-c may show completion information for previous completed reward offers. For example, on completion of a reward offer, a reward panel may be displayed. A connections progress symbol may appear to indicate that a rewards communication session has been established. A tile 730-d may show a landing page. When the rewards communication session is established, the landing page may be open automatically in a browser of the mobile device. The brand partner associated with the completed reward offer may determine the landing page. The passenger may choose to explore the brand partner's landing page or go on to explore the open Internet, for example.

The tiles 730 may be associated with a group of reward offers, as described herein. If passenger 180 wishes to select an offer type, they may interact with the corresponding tile 730 and toggle a select offer type button 735. In some examples, interacting with the tile 730 would select that offer type.

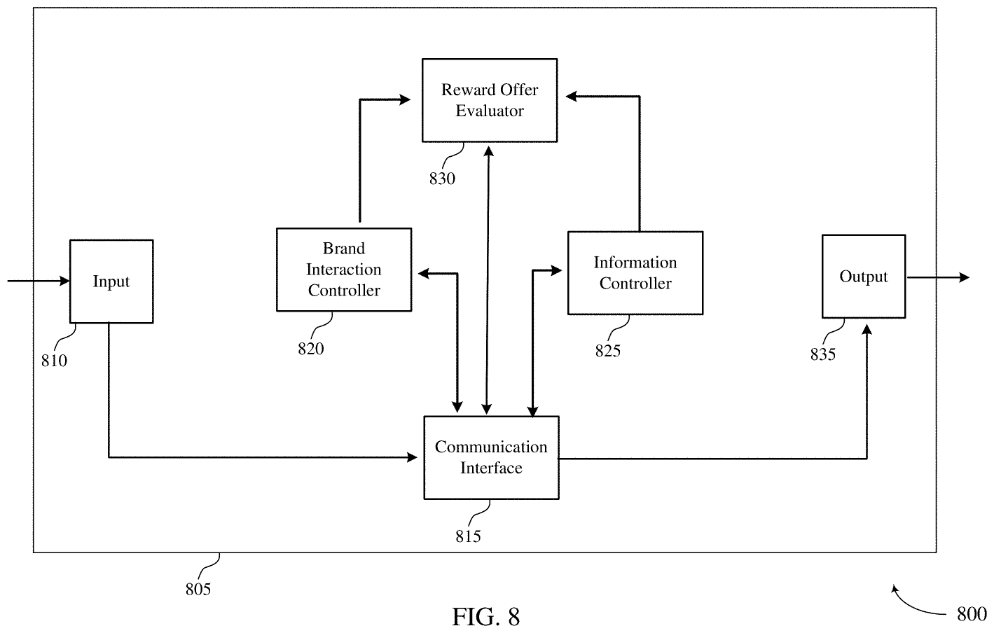

FIG. 8 shows a block diagram 800 of an apparatus 805 that supports techniques for user-level reward offer interface and management in accordance with aspects of the present disclosure. In some examples, apparatus 805 may be an example of a communication session delivery system 125 of FIGS. 1, 2, and 3. The apparatus 805 may include an input module 810, a communication interface 815, a brand interaction controller 820, an information controller 825, a reward offer evaluator 830, and an output module 835. The apparatus 805 may also include a processor. The components may communicate via one or more buses.

The apparatus 805 and/or at least some of its various sub-components may be implemented in hardware, software executed by a processor, firmware, or any combination thereof. If implemented in software executed by a processor, the functions of the apparatus 805 and/or at least some of its various sub-components may be executed by a general-purpose processor, a digital signal processor (DSP), an application-specific integrated circuit (ASIC), a field-programmable gate array (FPGA) or other programmable logic device (PLD), discrete gate or transistor logic, discrete hardware components, or any combination thereof designed to perform the functions described in the present disclosure. The apparatus 805 and/or at least some of its various sub-components may be physically located at various positions, including being distributed such that portions of functions are implemented at different physical locations by one or more physical devices. In some examples, the apparatus 805 and/or at least some of its various sub-components may be a separate and distinct component in accordance with various aspects of the present disclosure. In other examples, the apparatus 805 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

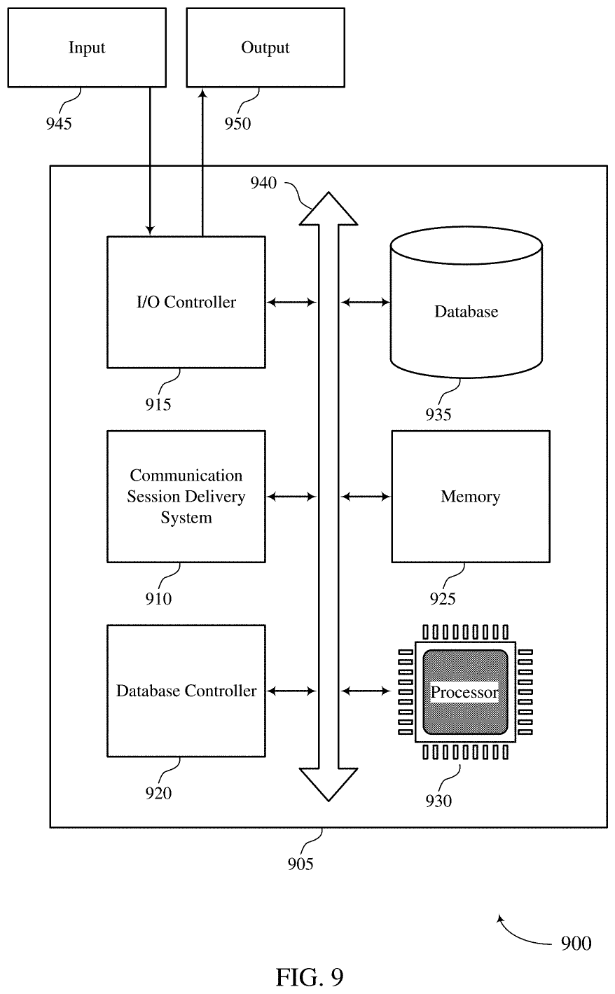

The input module 810 may manage input signals for the apparatus 805. For example, the input module 810 may identify input signals associated with user input or processing at other components or devices. In some cases, the input module 810 may utilize an operating system such as iOS®, ANDROID®, MS-DOS®, MS-WINDOWS®, OS/2®, UNIX®, LINUX®, or another known operating system to handle input signals. The input module 810 may send aspects of these input signals to other components of the apparatus 805 for processing. In some cases, the input module 810 may be a component of an input/output (I/O) controller 915 as described with reference to FIG. 9.

The communication interface 815 may serve as an interface between various modules of the apparatus 805, for example, the brand interaction controller 820, the information controller 825, and the reward offer evaluator 830, and input module 810 and output module 835. The communication interface 815 may provide the first group of reward offers of the plurality of reward offers to the passenger and establish a communication session over the wireless communications link for a communication device based at least in part on the completion of a respective brand interaction of a selected reward offer. In some examples, the communication interface 815 may present a metric related to the scarcity factor to the passenger with the subset of the plurality of reward offers. This metric may be a quantity of reward offers or a total number of minutes available for a travel segment, which may result from a scarcity factor being applied to a pool of rewards offers for the passenger during the travel segment. In some cases, the communication interface 815 may receive a unique identifier associated with the passenger. In an additional example, the communication interface 815 may present a redemption code associated with access to the communication session to the passenger based at least in part on receiving the indication of completion of the respective brand interaction and receive the redemption code at the network access unit.

The communication interface 815 may be configured as or otherwise support a means for presenting, to a passenger on the transport vessel, a first group of reward offers of the set of multiple reward offers, the first group of reward offers having first respective proportions of the set of multiple reward offer types. The communication interface 815 may present a comparison of the unused portion to a length of time of the travel segment to the passenger. In some examples, the communication interface 815 may present the one or more metrics to a respective brand partner associated with the one or more of the respective group of reward offers. In an additional example, the communication interface 815 may receive, from the passenger, a request for a modification of the subset of the plurality of reward offers. Additionally, the communication interface 815 may receive a selection of a reward offer from the provided subset from the passenger. In some examples, the communication interface 815 may be configured as or otherwise support a means for presenting, to the passenger, a second group of reward offers of the set of multiple reward offers, the second group of reward offers having second respective proportions of the set of multiple reward offer types.

In some examples, the communication interface 815 may be configured as or otherwise support a means for providing, based on the indication of completion by the passenger of the first brand interaction, a first communication session.

The brand interaction controller 820 may be configured as or otherwise support a means for receiving an indication of completion by the passenger of a first brand interaction associated with a selected reward offer of a first reward offer type. The brand interaction controller 820 may receive an indication of completion by the passenger of the respective brand interaction of a selected reward offer of the respective group of the plurality of reward offers. In some examples, the brand interaction controller 820 may determine completions of respective brand interactions of prior selected reward offers by the passenger. In some cases, the brand interaction controller 820 may identify one or more past brand interactions associated with the unique identifier. In an additional example, the communication interface 815 may identify one or more verified brand interactions associated with the unique identifier and aggregate values of respective rewards of each of the verified brand interactions associated with the unique identifier. A verified brand interaction may be a brand interaction conducted by a passenger of a travel segment that the brand interaction controller 820 has confirmed. In some cases, the brand interaction controller 820 may receive a second indication of the reward associated with the selected reward offer.

The information controller 825 may be configured as or otherwise support a means for determining the first group of reward offers or the second group of reward offers based on a characteristic associated with a travel segment of the transport vessel. The information controller 825 may identify profile information of a plurality of passengers scheduled for a travel segment of the transport vessel. In some examples, the information controller 825 may identify one or more metrics associated with prior interaction with one or more of the plurality of reward offers. In some cases, the information controller 825 may identify an identifier of the communication device associated with the verified completion of the respective brand interaction. In another example, the information controller 825 may determine interaction history data associated with the received plurality of reward offers. Additionally, the information controller may provide a unique identifier associated with the passenger.

The reward offer evaluator 830 may be configured as or otherwise support a means for identifying a set of multiple reward offers including respective brand interactions with a set of multiple brand partners and respective rewards related to the communication sessions, where the set of multiple reward offers include reward offers of a set of multiple reward offer types, and where the set of multiple reward offer types are associated with a set of multiple levels of engagement with brand partner services by passengers on the transport vessel. In some examples, the reward offer evaluator 830 may be configured as or otherwise support a means for determining the first group of reward offers or the second group of reward offers based on a characteristic associated with the passenger.

The reward offer evaluator 830 may receive a plurality of reward offers and select a first group or second group of the plurality of reward offers for a passenger from the plurality of passengers. In some examples, the reward offer evaluator 830 may determine a quantity of the group of reward offers based at least in part on a predetermined number. In some cases, the reward offer evaluator 830 may exclude reward offers of the plurality of reward offers associated with the completed respective brand interactions of the prior selected reward offers. In an additional example, the reward offer evaluator 830 may determine respective categories of the prior selected reward offers. Additionally, the reward offer evaluator 830 may determine respective categories of the prior selected reward offers. In some examples, the reward offer evaluator 830 may determine an aggregate reward comprising one or more rewards associated with a user account of the passenger. In other examples, the reward offer evaluator 830 may determine an unused portion of the determined aggregate reward.

The reward offer evaluator 830 may receive one or more respective bids associated with the plurality of reward offers. In some examples, the reward offer evaluator 830 may provide a modified group of the plurality of reward offers to the passenger.

The output module 835 may manage output signals for the apparatus 805. For example, the output module 835 may receive signals from other components of the apparatus 805 and may transmit these signals to other components or devices. In some specific examples, the output module 835 may transmit output signals for display in a user interface, for storage in a database or data store, for further processing at a server or server cluster, or for any other processes at any number of devices or systems. In some cases, the output module 835 may be a component of an I/O controller 915 as described with reference to FIG. 9.

In some examples, the set of multiple levels of engagement include a first level of engagement and a second level of engagement. In some examples, the second level of engagement is greater than the first level of engagement.

In some examples, the first level of engagement is associated with a first duration of engagement by the passengers and the second level of engagement is associated with second duration of engagement by the passengers. In some examples, the second duration is longer than the first duration. In some examples, the first reward offer type is associated with the first level of engagement.

In some examples, the first level of engagement is associated with a passive engagement by the passengers and a second level of engagement is associated with an active engagement by the passengers.

In some examples, the active engagement by the passengers includes a purchase from a brand partner associated with a respective reward offer, completion of a survey, submission of an email address, or interaction with a domain of a brand partner associated with a respective reward offer.

In some examples, the respective proportion of reward offers of the first reward offer type in the second group of reward offers is lower than the respective proportion of reward offers of the first reward offer type in the first group of reward offers.

In some examples, a quantity of reward offers of the first reward offer type in the second group of reward offers is lower than a quantity of remaining offers of the first reward offer type after excluding the selected reward offer.

In some examples, reward offers of the first reward offer type in the second group of reward offers corresponds to remaining offers of the first reward offer type after excluding the selected reward offer.

In some examples, receiving the indication of completion by the passenger includes receiving an indication that an amount of data transferred as part of the first brand interaction exceeds a data transfer threshold.

In some examples, receiving the indication of completion by the passenger includes receiving an indication that a duration associated with the first brand interaction exceeds a duration threshold.

In some examples, the set of multiple reward offer types are associated with different characteristics of the communication sessions provided upon completion by the passenger of the associated brand interaction.

In some examples, the different characteristics include a first type of communication session that is restricted to one or more domains and a second type of communication session that is unrestricted.

In some examples, the different characteristics include different durations of the communication sessions. In some examples, at least one of the sets of multiple reward offer types present in the first group of reward offers is absent from the second group of reward offers.

FIG. 9 shows a diagram of a system 900 including a device 905 that supports techniques for user-level reward offer interface and management in accordance with aspects of the present disclosure. The device 905 may be an example of or include the components of a communication session delivery system or an apparatus 805 as described herein. The device 905 may include components for bi-directional data communications including components for transmitting and receiving communications, including a communication session delivery system 910, an I/O controller 915, a database controller 920, memory 925, a processor 930, and a database 935. These components may be in electronic communication via one or more buses (e.g., bus 940).

The communication session delivery system 910 may be an example of a communication session delivery system 125 as described herein. In some cases, the communication session delivery system 910 may be implemented in hardware, software executed by a processor, firmware, or any combination thereof.

The I/O controller 915 may manage input signals 945 and output signals 950 for the device 905. The I/O controller 915 may also manage peripherals not integrated into the device 905. In some cases, the I/O controller 915 may represent a physical connection or port to an external peripheral. In some cases, the I/O controller 915 may utilize an operating system such as iOS®, ANDROID®, MS-DOS®, MS-WINDOWS®, OS/2®, UNIX®, LINUX®, or another known operating system. In other cases, the I/O controller 915 may represent or interact with a modem, a keyboard, a mouse, a touchscreen, or a similar device. In some cases, the I/O controller 915 may be implemented as part of a processor. In some cases, a user may interact with the device 905 via the I/O controller 915 or via hardware components controlled by the I/O controller 915.

The database controller 920 may manage data storage and processing in a database 935. In some cases, a user may interact with the database controller 920. In other cases, the database controller 920 may operate automatically without user interaction. The database 935 may be an example of a single database, a distributed database, multiple distributed databases, a data store, a data lake, or an emergency backup database.

Memory 925 may include random-access memory (RAM) and read-only memory (ROM). The memory 925 may store computer-readable, computer-executable software including instructions that, when executed, cause the processor to perform various functions described herein. In some cases, the memory 925 may contain, among other things, a basic input/output system (BIOS) which may control basic hardware or software operation such as the interaction with peripheral components or devices.

The processor 930 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 930 may be configured to operate a memory array using a memory controller. In other cases, a memory controller may be integrated into the processor 930. The processor 930 may be configured to execute computer-readable instructions stored in a memory 925 to perform various functions.

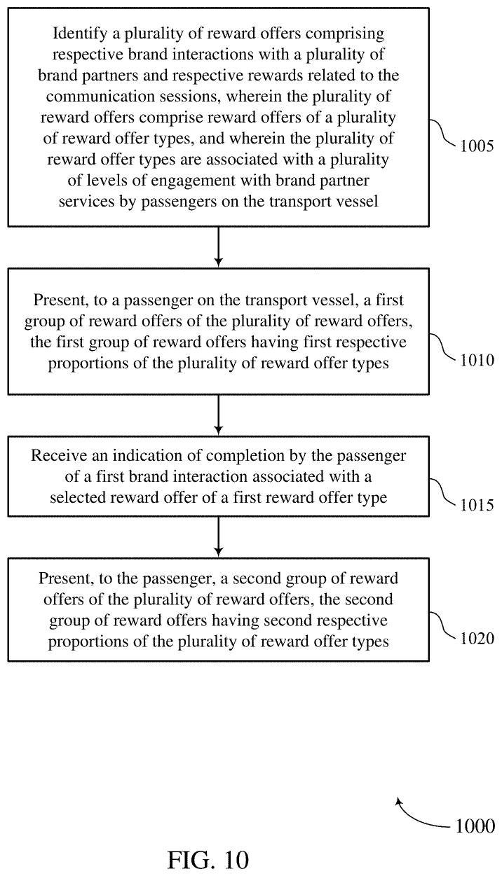

FIG. 10 shows a flowchart illustrating a method 1000 that supports techniques for user-level reward offer interface and management in accordance with aspects of the present disclosure. The operations of method 1000 may be implemented by a communication session delivery system or its components as described herein. For example, the operations of method 1000 may be performed by a communication session delivery system as described with reference to FIGS. 1 through 9. In some examples, a communication session delivery system may execute a set of instructions to control the functional elements of the communication session delivery system to perform the functions described herein. Additionally, or alternatively, a communication session delivery system may perform aspects of the functions described herein using special-purpose hardware.

At 1005, the communication session delivery system may identify a set of multiple reward offers including respective brand interactions with a set of multiple brand partners and respective rewards related to the communication sessions, where the set of multiple reward offers include reward offers of a set of multiple reward offer types, and where the set of multiple reward offer types are associated with a set of multiple levels of engagement with brand partner services by passengers on the transport vessel. The operations of 1005 may be performed in accordance with examples as disclosed herein. In some examples, aspects of the operations of 1005 may be performed by a reward offer evaluator 830 as described with reference to FIG. 8.

At 1010, the communication session delivery system may present to a passenger on the transport vessel, a first group of reward offers of the set of multiple reward offers, the first group of reward offers having first respective proportions of the set of multiple reward offer types. The operations of 1010 may be performed in accordance with examples as disclosed herein. In some examples, aspects of the operations of 1010 may be performed by a communication interface 815 as described with reference to FIG. 8.

At 1015, the communication session delivery system may receive an indication of completion by the passenger of a first brand interaction associated with a selected reward offer of a first reward offer type. The operations of 1015 may be performed in accordance with examples as disclosed herein. In some examples, aspects of the operations of 1015 may be performed by a brand interaction controller 820 as described with reference to FIG. 8.

At 1020, the communication session delivery system may present, to the passenger, a second group of reward offers of the set of multiple reward offers, the second group of reward offers having second respective proportions of the set of multiple reward offer types. The operations of 1020 may be performed in accordance with examples as disclosed herein. In some examples, aspects of the operations of 1020 may be performed by a communication interface 815 as described with reference to FIG. 8.

It should be noted that the methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.” Also, as used herein, including in the claims, a “subset” refers to one or more of a set of items. The subset may be, for example, one item of the set up to and including each item of the set.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for providing communication sessions within a transport vessel served via a wireless communications link, comprising:
identifying a plurality of reward offers comprising respective brand interactions with a plurality of brand partners and respective rewards related to the communication sessions, wherein the plurality of reward offers comprise reward offers of a plurality of reward offer types, and wherein the plurality of reward offer types are associated with a plurality of levels of engagement with brand partner services by passengers on the transport vessel;
presenting, to a passenger on the transport vessel, a first group of reward offers of the plurality of reward offers, the first group of reward offers having first respective proportions of the plurality of reward offer types;
receiving an indication of completion by the passenger of a first brand interaction associated with a selected reward offer of a first reward offer type; and
presenting, to the passenger, a second group of reward offers of the plurality of reward offers, the second group of reward offers having second respective proportions of the plurality of reward offer types.

2. The method of claim 1, wherein the plurality of levels of engagement comprises a first level of engagement and a second level of engagement, wherein the second level of engagement is greater than the first level of engagement.

3. The method of claim 2, wherein the first level of engagement is associated with a first duration of engagement by the passengers and the second level of engagement is associated with second duration of engagement by the passengers, wherein the second duration is longer than the first duration.

4. The method of claim 2, wherein the first level of engagement is associated with a passive engagement by the passengers and a second level of engagement is associated with an active engagement by the passengers.

5. The method of claim 4, wherein the active engagement by the passengers comprises a purchase from a brand partner associated with a respective reward offer, completion of a survey, submission of an email address, or interaction with a domain of a brand partner associated with a respective reward offer.

6. The method of claim 2, wherein the first reward offer type is associated with the first level of engagement.

7. The method of claim 6, wherein a respective proportion of reward offers of the first reward offer type in the second group of reward offers is lower than a respective proportion of reward offers of the first reward offer type in the first group of reward offers.

8. The method of claim 6, wherein a quantity of reward offers of the first reward offer type in the second group of reward offers is lower than a quantity of remaining offers of the first reward offer type after excluding the selected reward offer.

9. The method of claim 6, wherein reward offers of the first reward offer type in the second group of reward offers corresponds to remaining offers of the first reward offer type after excluding the selected reward offer.

10. The method of claim 1, wherein receiving the indication of completion by the passenger includes receiving an indication that an amount of data transferred as part of the first brand interaction exceeds a data transfer threshold.

11. The method of claim 1, wherein receiving the indication of completion by the passenger includes receiving an indication that a duration associated with the first brand interaction exceeds a duration threshold.

12. The method of claim 1, wherein the plurality of reward offer types are associated with different characteristics of the communication sessions provided upon completion by the passenger of an associated brand interaction.

13. The method of claim 12, wherein the different characteristics comprise a first type of communication session that is restricted to one or more domains and a second type of communication session that is unrestricted.

14. The method of claim 12, wherein the different characteristics comprise different durations of the communication sessions.

15. The method of claim 1, wherein at least one of the plurality of reward offer types present in the first group of reward offers is absent from the second group of reward offers.

16. The method of claim 1, further comprising:
determining the first group of reward offers or the second group of reward offers based at least in part on a characteristic associated with a travel segment of the transport vessel.

17. The method of claim 1, further comprising:
determining the first group of reward offers or the second group of reward offers based at least in part on a characteristic associated with the passenger.

18. The method of claim 1, further comprising:
providing, based at least in part on the indication of completion by the passenger of the first brand interaction, a first communication session.

19. An apparatus for providing communication sessions within a transport vessel served via a wireless communications link, comprising:
a reward offer evaluator configured to identify a plurality of reward offers comprising respective brand interactions with a plurality of brand partners and respective rewards related to the communication sessions, wherein the plurality of reward offers comprise reward offers of a plurality of reward offer types, and wherein the plurality of reward offer types are associated with a plurality of levels of engagement with brand partner services by passengers on the transport vessel;
a communication interface configured to present, to a passenger on the transport vessel, a first group of reward offers of the plurality of reward offers, the first group of reward offers having first respective proportions of the plurality of reward offer types; and
a brand interaction controller configured to receive an indication of completion by the passenger of a first brand interaction associated with a selected reward offer of a first reward offer type,
wherein the communication interface is configured to present, to the passenger, a second group of reward offers of the plurality of reward offers, the second group of reward offers having second respective proportions of the plurality of reward offer types.

20. The apparatus of claim 19, wherein the plurality of levels of engagement comprises a first level of engagement and a second level of engagement, wherein the second level of engagement is greater than the first level of engagement.

21. The apparatus of claim 20, wherein the first level of engagement is associated with a first duration of engagement by the passengers and the second level of engagement is associated with second duration of engagement by the passengers, wherein the second duration is longer than the first duration.

22. The apparatus of claim 20, wherein the first level of engagement is associated with a passive engagement by the passengers and a second level of engagement is associated with an active engagement by the passengers.

23. The apparatus of claim 22, wherein the active engagement by the passengers comprises a purchase from a brand partner associated with a respective reward offer, completion of a survey, submission of an email address, or interaction with a domain of a brand partner associated with a respective reward offer.

24. The apparatus of claim 20, wherein the first reward offer type is associated with the first level of engagement.

25. The apparatus of claim 24, wherein a respective proportion of reward offers of the first reward offer type in the second group of reward offers is lower than a respective proportion of reward offers of the first reward offer type in the first group of reward offers.

26. The apparatus of claim 24, wherein a quantity of reward offers of the first reward offer type in the second group of reward offers is lower than a quantity of remaining offers of the first reward offer type after excluding the selected reward offer.

27. The apparatus of claim 24, wherein reward offers of the first reward offer type in the second group of reward offers corresponds to remaining offers of the first reward offer type after excluding the selected reward offer.

28. The apparatus of claim 19, wherein receiving the indication of completion by the passenger includes receiving an indication that an amount of data transferred as part of the first brand interaction exceeds a data transfer threshold.

29. The apparatus of claim 19, wherein receiving the indication of completion by the passenger includes receiving an indication that a duration associated with the first brand interaction exceeds a duration threshold.

30. The apparatus of claim 19, wherein the plurality of reward offer types are associated with different characteristics of the communication sessions provided upon completion by the passenger of an associated brand interaction.

31. The apparatus of claim 30, wherein the different characteristics comprise a first type of communication session that is restricted to one or more domains and a second type of communication session that is unrestricted.

32. The apparatus of claim 30, wherein the different characteristics comprise different durations of the communication sessions.

33. The apparatus of claim 19, wherein at least one of the plurality of reward offer types present in the first group of reward offers is absent from the second group of reward offers.

34. The apparatus of claim 19, further comprising:
an information controller configured to determine the first group of reward offers or the second group of reward offers based at least in part on a characteristic associated with a travel segment of the transport vessel.

35. The apparatus of claim 19, the reward offer evaluator further configured to:
determine the first group of reward offers or the second group of reward offers based at least in part on a characteristic associated with the passenger.

36. The apparatus of claim 19, the communication interface further configured to:
provide, based at least in part on the indication of completion by the passenger of the first brand interaction, a first communication session.
